(19) United States
(12) Patent Application Publication
(10) Pub. No.: US 2001/0023227 A1
(43) Pub. Date: Sep. 20, 2001

(54) Method and system for transferring cardboard blanks in individual succession

(75) Inventor: Mario Gambetti, Bologna (IT)

Correspondence Address: THE FIRM OF KARL F ROSS, 5676 RIVERDALE AVENUE, PO BOX 900, RIVERDALE (BRONX), NY, 10471-0900, US

(73) Assignee: BAUMER S.r.l.

(21) Appl. No.: 09/808,236

(22) Filed: Mar. 14, 2001

(30) Foreign Application Priority Data
Mar. 15, 2000 (IT) B02000A000137

(51) Int. Cl. B31B 1/02

(52) U.S. Cl. 493/71

(57) ABSTRACT

A method for transferring cardboard blanks (7) in individual succession in a plant, comprising a store (1) for collection of cardboard blanks (7b), a conveyor (3), with an upstream portion (3a) which is designed to receive the cardboard blanks (7a), and a rotary collector-translator (2), comprising one or a plurality of orbiting gripper units (100, 200), wherein the cardboard blank is grasped in the store (1), extracted, translated and spaced, whilst being kept substantially parallel to the successive cardboard blank (7c), which is still disposed in the vicinity of the downstream end (1a) of the store (1); and is then inclined, and placed parallel on the upstream portion (3a) of the conveyor (3). A corresponding system, and a corresponding rotary collector-translator.

### FIELD OF THE INVENTION

The present invention relates to a method and a system for transferring cardboard blanks.

### DESCRIPTION OF THE PRIOR ART

At present, with particular reference to the field of packaging and/or wrapping machines, various systems for transferring cardboard blanks are known, but the said systems are substantially unable to collect and supply at high speed flat cardboard blanks with large dimensions.

### BRIEF SUMMARY OF THE INVENTION

The object of the present invention is to eliminate the above-described disadvantage.

The invention, which is characterised by the claims, solves the problem of creating a method for transferring cardboard blanks in individual succession, in a plant comprising: a store for collection of cardboard blanks, which extends longitudinally along its own longitudinal axis, and is designed to present in the vicinity of its downstream end the cardboard blanks to be transferred; a conveyor, which extends longitudinally along its own longitudinal axis, which is disposed aligned relative to the preceding axis of the store, wherein the upstream portion of the said conveyor is designed to receive the cardboard blanks; a rotary collector-translator, which is designed to rotate relative to an axis which is disposed perpendicular to the axes of extension of the store and of the conveyor, and is disposed between the downstream end of the said store and the upstream portion of the said conveyor, and comprises one or a plurality of orbiting gripper units, which are designed to collect the cardboard blanks in succession from the downstream end of the store, and then to translate them onto the upstream portion of the conveyor, wherein the said method is characterised in that the transfer of each individual cardboard blank comprises the following operations: a)-gripping of the cardboard blank at the downstream end of the store; b)-extraction of the cardboard blank from the downstream end of the store; c)-translation of the cardboard blank towards the axis of rotation of the rotary collector-translator, whilst keeping the said cardboard blank substantially parallel relative to the successive cardboard blank, which is still disposed in the vicinity of the downstream end of the store; d)-spacing the cardboard blank which is being translated, from the successive cardboard blank, which is still disposed in the vicinity of the downstream end of the store, whilst keeping the said cardboard blank which is being translated substantially parallel to the successive cardboard blank, which is still disposed in the vicinity of the downstream end of the store; e)-inclining the cardboard blank which is being translated, whilst taking its front portion towards and above the upstream portion of the conveyor; f)-placing at least this front portion of the cardboard blank which is being translated, parallel above, and in contact with, the upstream portion of the conveyor.

In conformity with the above-described objective, the same invention also solves the problem of creating a system for transferring cardboard blanks in individual succession in a plant of the above-described type, wherein the said system is characterised in that each of the said orbiting gripper units comprises one or a plurality of suckers, which are controlled such as to move in respective orbital paths, which are disposed in respective planes perpendicular to the axis of rotation of the said rotary collector-translator, in that the upstream portion of the said conveyor extends within the operative context of the orbital path of the said suckers, and in that in the execution of their orbital path, the said suckers pass adjacent to the said upstream portion of the conveyor.

Finally, again in conformity with the preceding objectives, this invention also solves the problem of creating a rotary collector-translator which is provided with orbiting gripper units, which are circumferentially equally spaced, wherein the said rotary collector-translator is characterised in that each orbiting gripper unit comprises: -an orbiting and oscillating shaft, which is supported such as to be rotated by, and between, two rotary elements, in the vicinity of their radial periphery, is oriented parallel to the said axis of rotation of the rotary collector-translator, and is designed to orbit along a circular path; one or a plurality of arms, which can be inclined in respective planes which are perpendicular to the said axis of rotation, and have one end which is secured to the said orbiting and oscillating shaft, and the opposite end which is designed to support respective orbiting suckers; a first toothed wheel, which is keyed onto the said orbiting and oscillating shaft; a second toothed wheel, which is supported such as to rotate adjacent to the said first toothed wheel, by means of a pin which projects axially from one of the said rotary elements; a toothed belt, which is wound around the said first toothed wheel and around the said second toothed wheel; and a lever, which has a first end secured to the said second toothed wheel, and the opposite, or second, end designed to support in an idle rotary manner a cam-follower roller, and in that the said cam-follower rollers of each orbiting gripper unit are designed to follow the profile of a common stationary cam.

A first advantage of the present invention consists in the fact that it is possible to transfer at high speed cardboard blanks which have large dimensions, with a consequent increase in the production capacity of the corresponding packaging machines.

A further advantage of the present invention consists in the fact that the said transfer at high speed takes place by means of positive translation, wherein, substantially, the cardboard blanks are always firmly grasped by the operative means, with consequent reduction of possible jamming caused by malfunctioning.

Further characteristics and advantages of the present invention will become more apparent from the following description of a preferred practical embodiment, provided here purely by way of non-limiting example, with reference to the figures in the attached drawings.

### BRIEF DESCRIPTION OF THE SEVERAL VIEWS OF THE DRAWINGS

FIG. 1 is a detailed, perspective, schematic view of the present invention;

FIG. 2 is a lateral schematic view of the method and the system which are the subject of the present invention, according to a first operative configuration;

FIGS. 3, 4, 5, 6, 7 and 8 illustrate schematically seven operative configurations subsequent to that illustrated in FIG. 2; and

FIG. 9 is a lateral schematic view of the method and the system which are the subject of the present invention, according to a variant embodiment.

### DETAILED DESCRIPTION OF THE PREFERRED EMBODIMENTS OF THE INVENTION

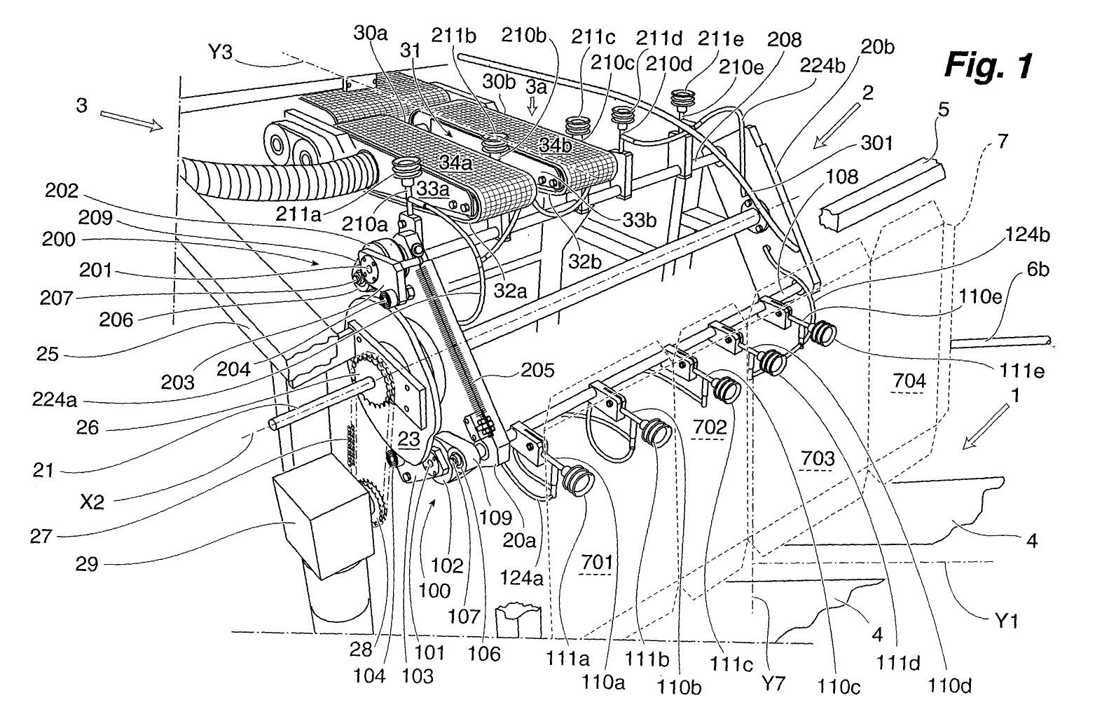

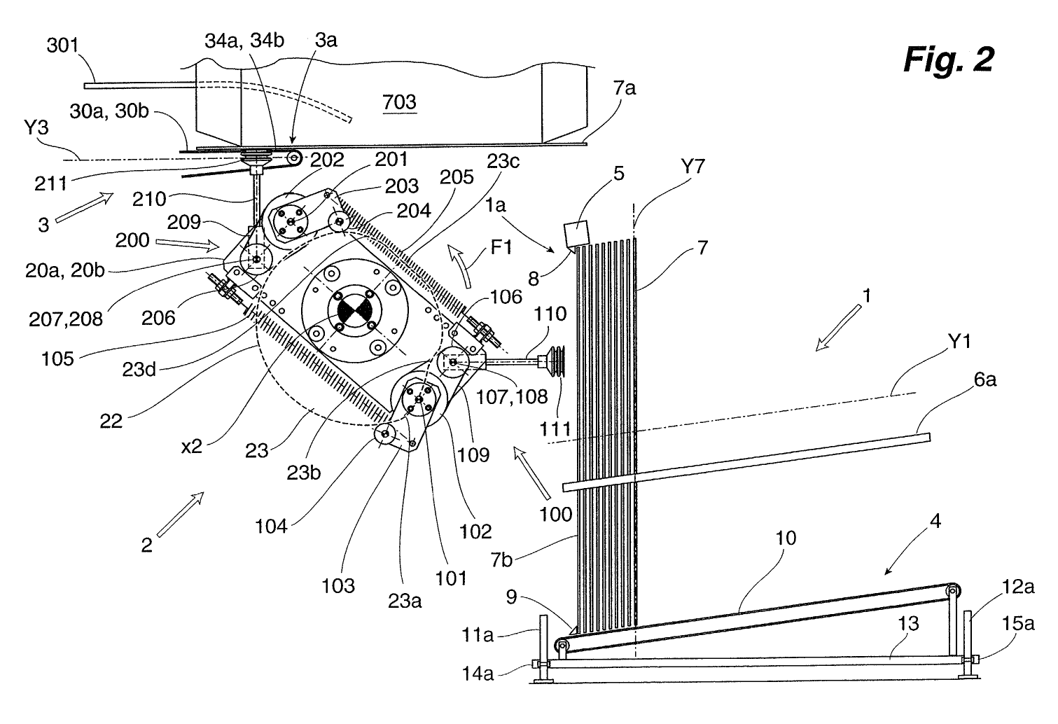

With reference to FIGS. 1 and 2, the system which is the subject of the present invention substantially comprises a store 1, a rotary collector-translator 2, and a receiver conveyor 3. Store

The store 1 extends longitudinally along an axis Y1, comprising a bed 4 which is inclined longitudinally from upstream towards downstream, and from top to bottom, an upper cross member 5 which is disposed downstream, and lateral guides 6a and 6b, in order to constitute a tray, which is designed to carry, vertically and supported sideways, a plurality of cardboard blanks 7, each of which extends along a longitudinal-vertical supply axis Y7, wherein, in the vicinity of the downstream end 1a of the said store 1, the said cardboard blanks 7 are retained by means of a plurality of stop teeth, indicated as 8 and 9.

Preferably, the collection bed 4 consists of a conveyor 10, which is designed to advance the cardboard blanks 7 in the downstream direction, wherein the said conveyor 10 is actuated by means of an electric servomotor, and in this case a phase and speed control servomotor, such as a brushless servomotor.

The said store 1 is supported at the base and suspended, by means of a rectangular tubular frame 13, which in turn is supported by four legs disposed in the vicinity of the corresponding four vertices, wherein only two legs 11a and 12a can be seen in FIG. 2, whereas the other two legs are arranged specularly on the other side of the store 1.

Each of the said four legs 11a and 12a, and the other two on the other side have respective lifting means 14a, 15a, and another two on the other side, such as a scroll which extends vertically, can be rotated by command, and engages with a nut screw which is secured to the four vertices of the said rectangular frame 13, in order to be able to raise or lower the said store 1.

Collector-Translator

Between the downstream end of the store 1, and the upstream portion of the conveyor 3, there is disposed the rotary collector-translator 2, which is designed to rotate around an axis X2, which has two separate orbiting gripper units, which are indicated as 100 and 200 as a whole.

Each of the said orbiting gripper units 100 and 200 comprises a respective plurality of suckers 111 and 211, indicated individually as 111a, 111b, 111c, 111d, 111e and 211a, 211b, 211c, 211d, 211e, wherein a first series of suckers 111a, 111b, 111c, and 211a, 211b, 211c, is controlled by means of respective pneumatic distribution 124a and 224a, whereas a second series of suckers 111d, 111e and 211d, 211e is controlled by means of respective second pneumatic distribution 124b and 224b.

The respective suckers 111 and 211 of each orbiting gripper unit 100 and 200 are supported on a first end of respective arms 110 and 210, indicated individually as 110a, 110b, 110c, 110d, 110e, and 210a, 210b, 210c, 210d, 210e, which have their opposite or second ends secured to respective orbiting and oscillating shafts 108 and 208, which are supported such as to be rotated by means of two rotary elements 20a and 20b, which are disposed opposite one another, spaced, and keyed onto a common shaft 21, which is designed to rotate on the axis X2 of the said rotary collector-translator 2, such as to incline the said arms 110a-210a, 110b-210b, 110c-210c, etc, in respective planes which are perpendicular to the said axis of rotation X2, in phase ratio during rotation of the said rotary collector-translator 2, as described in greater detail hereinafter.

The said shaft 21 has its opposite end supported by the frame 25 of the machine, and, for its motorisation, has keyed onto it a toothed wheel 26, around which there is wound a chain 27, which is also wound around a toothed wheel 28, wherein the latter is rotated by means of an electric servomotor 29, in this case a phase and speed control servomotor, such as a brushless servomotor.

Each of the said orbiting shafts 108 and 208 has respective end portions 107 and 207, which extend beyond the rotary element 20a, in order to support, keyed onto them, respective first toothed wheels 106 and 206, around which there are wound respective toothed belts 109 and 209, which are also wound around respective second toothed wheels 102 and 202, disposed adjacent to the respective first toothed wheels, 106 and 206, wherein the said second toothed wheels 102 and 202 are supported such as to rotate in an idle manner, by means of respective pins 101 and 201, which are supported such as to project axially towards the exterior, by the said rotary element 20a.

The second toothed wheels 102 and 202 support integrally the first ends of respective levers 103 and 203, the opposite or second ends of which support such as to rotate in an idle manner respective cam-follower rollers 104 and 204, wherein, in operation, as described in greater detail hereinafter, the latter are designed to follow the profile 22 of a common stationary disc cam 23, which is supported by, and secured to, the machine frame 25.

In order to keep the respective cam-follower rollers 104 and 204 pressed against the profile 22 of the cam 23, respective return springs 105 and 205 are provided, which are subjected to traction, and have their respective first ends secured to the second, free ends of the respective levers 103 and 203, and have their opposite ends secured to the rotary element 20a.

As will become more apparent hereinafter, by means of this structuring, during the rotation of the two opposite elements 20a-20b, the respective suction suckers 111a, 111b, 111c, 111d, 111e and 211a, 211b, 211c, 211d, 211e of each orbiting gripper unit are moved along respective orbital paths disposed in respective planes, which are perpendicular to the axis of rotation X2, and, additionally, whilst the said paths are being followed, the gripping plane which is configured by the said suckers 111 and 211 assumes different orientations, which are determined by the profile 22 of the stationary cam 23, on which the respective cam followers 104 and 204 run.

Receiver Conveyor

The receiver conveyor 3 extends longitudinally along the longitudinal axis Y3, and has a upstream portion 3a, which is designed to receive and grasp the cardboard blanks 7 which are presented by the said collector-translator 2, wherein the said upstream portion 3a extends within the operative scope of the orbital path of the said suckers 111 and 211.

More particularly, the said conveyor 3 preferable comprises two suction transporters 30a and 30b, which extend longitudinally, which form the upstream portion 3a of the conveyor 3, wherein the said upstream portion 3a extends without interfering, within the operative scope of the orbital path of the suction suckers 111 and 211.

The two suction transporters 30a and 30b have a pre-determined transverse amplitude, in order not to interfere with the orbital path of the suckers 111a-211a and 111c-211c, which pass in the vicinity of the opposite sides of the said upstream portion 3a, and, more particularly, respectively in the vicinity of the outer side of the transporter 30a, and in the vicinity of the outer side of the transporter 30b.

The said two transporters 30a and 30b are also disposed transversely spaced from one another, in order to create an aperture 31, which is aligned with the plane in which the suction suckers 111b and 211b orbit, wherein the said aperture has an amplitude such as to permit passage, without interfering with the suction suckers 111b and 211b themselves.

However, in this context, it should be pointed out that the said upstream portion 3a of the conveyor 3 can be formed by a single transporter, such as the transporter 34a only, on the opposite sides of which the suckers 111a-211a and 111b-211b pass freely, or, preferably, by two separate transporters 30a and 30b, between which there is provided an aperture 31 for passage of the suckers 111b-211b, or, similarly and equivalently, by a plurality of transporters provided with a plurality of apertures for free passage of a plurality of suckers.

Each of the said transporters 30a and 30b comprises respective conveyor

belts 32a and 32b of the porous type, which are wound around a closed path on respective supports 33a and 33b, wherein the latter have in their interior a duct which is open at the top, and is connected by means of tubes to a suction source, not illustrated, in order to create suction on the upper branch 34a and 34b of each of the said transporters 30a and 30b.

The said conveyor 3 is preferably actuated by means of an electric servomotor, and in this particular case a phase and speed control servomotor, such as a brushless servomotor.

The above-described system also has means for mechanical and/or electrical and/or electronic synchronisation and control, in order to synchronise the motion between the said store 1, the said rotary collector-supplier 2, and the said conveyor 3, and in order to control their correct functioning.

Functional Description

FIGS. 2 to 8 illustrate schematically in succession seven particular operative configurations assumed by the method and the system which both constitute the subject of the present invention, at 30° intervals of rotation of the rotary collector-translator 2, which during functioning rotates in the direction F1.

With reference to FIG. 2, the suckers 111 of the orbiting gripper unit 100, which have their gripping plane substantially parallel to the plane in which the cardboard blank 7b is disposed, prepare to come into contact with the cardboard blank 7b itself, which is disposed in the vicinity of the downstream end 1a of the store 1, whereas, in an opposite direction, the suckers 211 of the orbiting gripper unit 200, which have their gripping plane parallel to the receiver branch 34a-34b of the upstream portion 3a of the conveyor 3, prepare to deposit and release a preceding cardboard blank 7a onto the said upstream portion 3a.

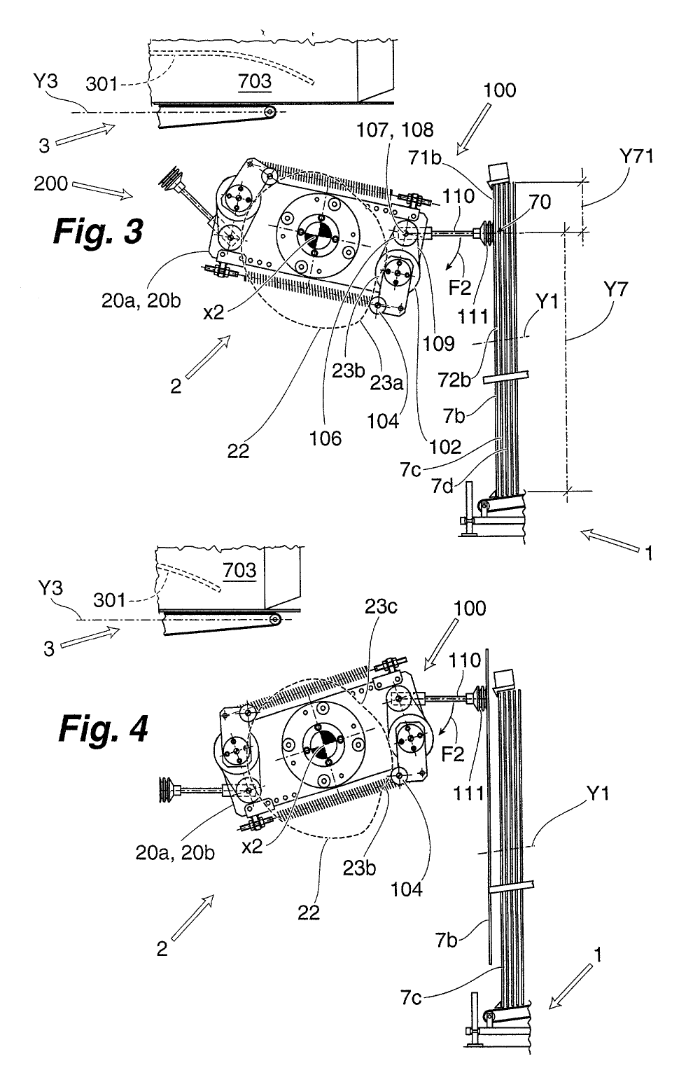

With reference to FIG. 3, after the two rotary elements 20a-20b have rotated, the suckers 111 have come into contact with the cardboard blank 7b in a particular area 70 of its longitudinal extension Y7, thus giving rise to a front portion 71b of cardboard blank, and a rear portion 72b of cardboard blank.

During the said step, the profile 22 of the stationary cam 23 on which the roller 104 runs, is displaced towards the centre X2, see segment 23a-23b, such as to oscillate the second wheel 102 clockwise, and, by means of the belt 109, also the first wheel 106, with consequent similar oscillation of the orbiting shaft 107-108, and corresponding inclination, in the direction F2, of the arm 110, and of the corresponding sucker 111, thus generating relative movement between the rotary elements 20a-20b and the suckers 111, wherein the said relative movement is such as to create a halt in the orbital path of the suckers 111 (i.e. a halt of the upstream movement), wherein, substantially, during this halt, all the suckers 111, in which suction is created by means of the pneumatic distributors 124a and 124b, owing also to the circumferential orbital path followed by the orbiting and oscillating shaft 107-108, are firstly moved towards the cardboard blank 7b, and then towards the axis of rotation X2, see also FIG. 4, such as to come into contact with, grasp, and extract, the cardboard blank 7b, whilst keeping it substantially perpendicular to the other stacked cardboard blanks 7c, 7d, etc.

With reference to FIG. 4, after the two rotary elements 20a-20b have rotated, the suckers 111 have translated the cardboard blank 7b from the downstream end of the store 1 towards the centre of rotation X2, and the profile 22 of the cam 23, which forms the path of the roller 104, is displaced further towards the centre of rotation X2, see segment 23b-23c, such as to incline the arm 110 and the corresponding suckers 111 further in the direction F2, relative to the two rotary elements 20a-20b, in order to translate the cardboard blank 7b towards the centre of rotation X2, and slightly upwards, still keeping it substantially parallel relative to the successive cardboard blank 7c.

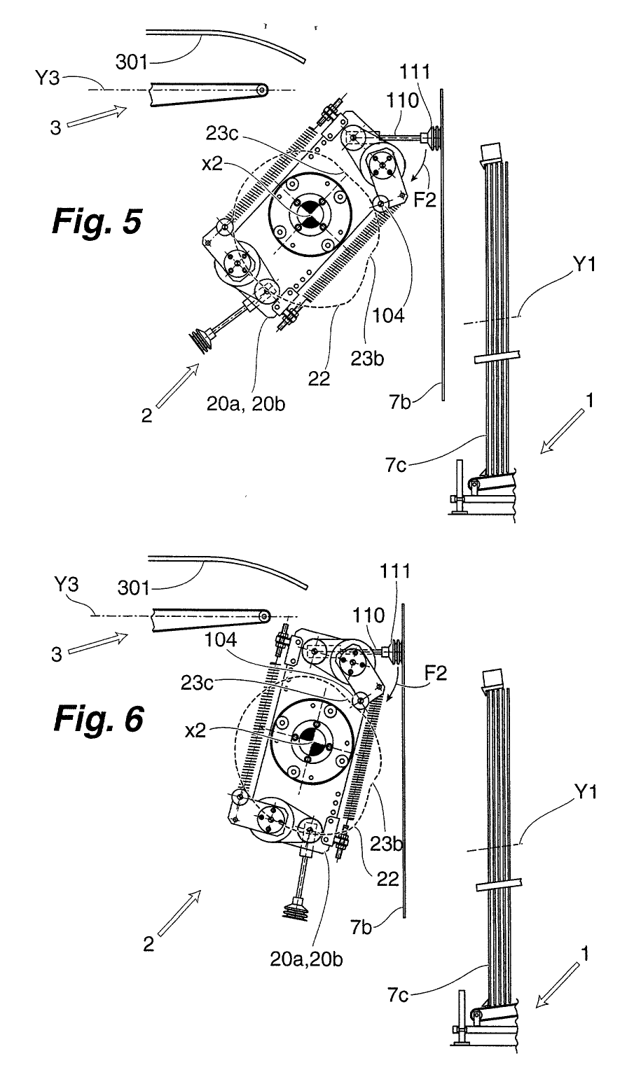

With reference to FIG. 5, after the two rotary elements 20a-20b have rotated, the suckers 111 have translated the cardboard blank 7b further towards the centre of rotation X2 and upwards, and the profile 22 of the cam 23, which forms the path of the roller 104, is displaced further towards the centre X2, again see segment 23b-23c, such as to incline the arm 110 and the corresponding suckers 111 further in the direction F2, relative to the two rotary elements 20a-20b, in order to translate the cardboard blank 7b towards the centre of rotation X2, and slightly upwards, still keeping it substantially parallel relative to the successive cardboard blank 7c.

With reference to FIG. 6, after the two rotary elements 20a-20b have rotated, the suckers 111 have translated the cardboard blank 7b further towards the centre of rotation X2 and upwards, and the profile 22 of the cam 23, which forms the path of the roller 104, is displaced further towards the centre X2, again see segment 23b-23c, such as to incline the arm 110 and the corresponding suckers 111 further in the direction F2, relative to the two rotary elements 20a-20b, in order to translate the cardboard blank 7b towards the centre of rotation X2, and slightly upwards, still keeping it substantially parallel relative to the successive cardboard blank 7c.

In this context, for the reasons which will become more apparent hereinafter, it must be emphasised that approximately 50% of the orbital path which is necessary in order for the orbiting and oscillating bars 108 and 208 to be able to execute the complete transfer cycle, i.e. a considerable percentage of the said cycle, has been used substantially to space the said cardboard blank 7b significantly from the successive cardboard blank 7c, thus keeping the said cardboard blank 7b which is being transferred parallel to that 7c which is kept in the store 1.

In fact, with particular reference to the embodiment described here, in which complete transfer takes place after rotation of 180° by the rotary collector-translator 2, approximately 90° of the said rotation has been used to space the cardboard blank extracted from that which is still kept in the store 1, and, similarly, in the hypothesis of a rotary collector-translator which is provided with three collector-translator units which are disposed circumferentially equidistantly spaced by the 120° necessary in order to execute a complete transfer cycle, approximately 60° would have been used in order to space the cardboard blank extracted, from that which is still kept in the store.

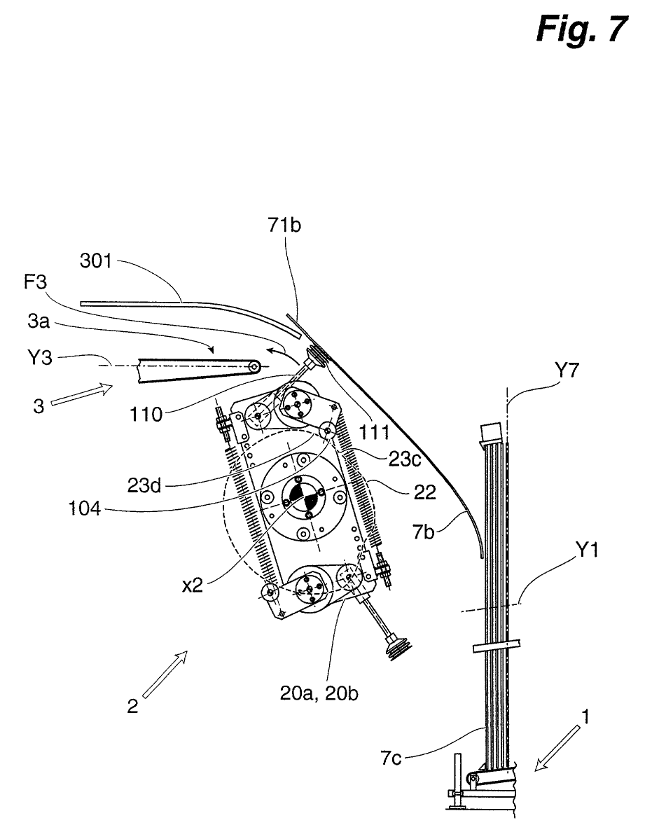

With reference to FIG. 7, after the two rotary elements 20a-20b have rotated, the suckers 111 have translated the cardboard blank 7b towards the upstream portion 3a of the conveyor 3 and upwards, and the profile 22 of the cam 23, which forms the path of the roller 104, is displaced towards the exterior, see the path 23c-23d, such as to incline the arm 110 and the corresponding sucker 111 in the direction F3 relative to the two rotary elements 20a-20b, in order to incline the cardboard blank 7b relative to its preceding position, and in order to direct the front portion 71b of the same cardboard blank 7b onto the upstream portion 3a of the conveyor 3.

In this context, as previously stated, it should be pointed out that, in the preceding operative steps, see FIGS. 3 to 6, having translated and spaced the cardboard blank 7b which is being translated, from the successive cardboard blank 7c which is kept in the store 1, still keeping the said cardboard blank 7b which is being translated parallel to the successive cardboard blank 7c, only a small portion of the tail of the cardboard blank 7b interferes with the successive cardboard blank 7c, and, again in this context, it should also be pointed out that the said minor interference is such as not to affect adversely the correct translation-inclination of the cardboard blank 7b.

In addition, the aforementioned minor interference occurs when use is made of cardboard blanks which have large dimensions in relation to their longitudinal axis of extension Y7, and thus, the said interference does not occur when use is made of cardboard blanks with smaller longitudinal dimensions, or when a rotary collector-translator 2 with larger dimensions (i.e. lager diameter) is used.

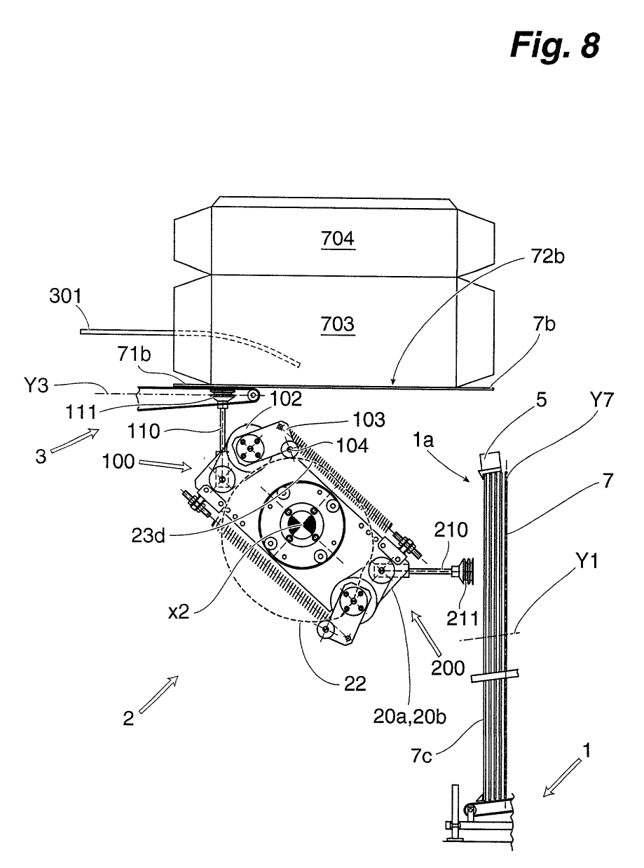

With reference to FIG. 8, after the two rotary elements 20a-20b have rotated, the suckers 111 have translated and inclined the cardboard blank 7b further until it is disposed parallel on the upstream portion 3a of the conveyor 3, and, more specifically, until at least the front portion 71b and a front part of the rear portion 72b are disposed parallel on the branches 34a and 34b of the two transporters 30a and 30b, wherein, in order to obtain this configuration, the sucker 111b is inserted between the said two transporters 30a and 30b, using the aperture 31, the sucker 111a is disposed on the outer side of the transporter 30a, and the sucker 111c is disposed on the outer side of the transporter 30b.

In order to obtain this configuration, the profile 22 of the cam 23, which forms the path of the roller 104, provides calibrated displacement, see the downstream path of the point 23d, which is designed to incline the arms 110 and the corresponding suckers 111 such that the gripping plane of the said suckers 111 is parallel to the upper receiver plane 34a and 34b of the two transporters 30a and 30b.

Again in this configuration, whilst keeping the cardboard blank 7b in the aforementioned arrangement, the suckers 111 are then lowered, thus placing the front portion 71b, as well as a front part of the rear portion 72b, against the upper branches 34a and 34b of the conveyor 3, in order then to deactivate the same suckers 11 (by eliminating their suction), such as to permit gripping and translation in the downstream direction of the cardboard blank 7b, by means of the suction conveyors 32a and 32b, which subsequently release the said upstream portion 3a of the conveyor 3 from the cardboard blank 7b which has just been transferred, as was previously the case for the cardboard blank 7a, in order to be able to receive the new cardboard blank 7c.

Again in this configuration, FIG. 8, the orbiting gripper unit 200 has assumed the position of the orbiting gripper unit 100 illustrated in FIG. 2, and the said orbiting gripper unit 200 begins an operative cycle which is identical to that previously described for the orbiting gripper unit 100.

With reference to the preceding description, the collector-translator described and illustrated by way of example has two opposite orbiting gripper units 100 and 200, but, in this context, it is apparent that it is possible to produce equivalent rotary collector-translators which have a single orbiting gripper unit, or rotary collector-translators which have three or more orbiting gripper units, which will be disposed circumferentially equally spaced, and these alternative embodiments are also designed to implement in an equivalent manner the method and system previously described, and claimed hereinafter.

Change of Format

With reference to the preceding description of the system, in the event of a change of format, i.e. when use is made of cardboard blanks which have larger and/or smaller longitudinal dimensions, it is possible to execute the said change of format, without replacing the so-called “format parts”.

In fact, in this context, the store 1 is raised or lowered in relation to the axis of rotation X2 of the rotary collector-translator 2, by raising or lowering the rectangular frame 13 by adjusting the means 14a and 15a, and the other two means on the other side, in order, with the different cardboard blank, to obtain a gripping area 70 for the suckers 111 and 211, see FIG. 3, with a front portion 71b of cardboard blank which always has substantially the same longitudinal length Y71.

In fact, by keeping the said length Y71 the same, even for cardboard blanks which have different dimensions, the execution of the operative steps previously described with reference to the first cardboard blank 7b, takes place in operative and spatial environments which are substantially identical, wherein the only variant is that relating to the operative and spatial environments of the downstream or tail end of the new cardboard blank, wherein, as previously described, greater or lesser interference of the rear or tail end of the cardboard blank being translated, with the successive cardboard blank which is still disposed in the store 1, does not affect adversely the correct transfer.

Suction Suckers which are Controlled Separately

According to this practical embodiment, optionally, see FIG. 1, by means of the respective first pneumatic distribution 124a and 224a, the suction of the first series of suckers 111a, 111b, 111c, and 211a, 211b, 211c is made operative throughout the entire cycle of collection and translation (FIGS. 3 to 8), whereas, by means of the respective second pneumatic distribution 124b and 224b, the suction of the second series of suckers 111d, 111e and 211d, 211e is made operative during the collection step (FIG. 3), and during the step of commencement of translation (FIGS. 4-6), and the suckers are then deactivated (by eliminating their suction), in order, by means of fixed folding units indicated as 301, which are disposed along the translation path, to permit folding of a longitudinal portion 703-704 of the cardboard blank 7 during the steps of completion of translation, illustrated in FIGS. 7 and 8.

In this context, for example, again see FIGS. 3 to 8, with reference to the orbiting unit indicated as 100, using a cardboard blank 7b which has four separate panels indicated as 701, 702, 703, 704, the suckers 111 are disposed such that the first series of suckers 111a, 111b, 111c is designed to grasp the panels 701 and 702, and the second series of suckers 111d, 111e is designed to grasp the panels 703 and 704, in order then to extract (FIG. 4) and translate (FIGS. 4,5,6) the cardboard blank 7b towards the axis X2, keeping all the said suckers 111 active, and then to release the grip for the second series of suckers 111d, 111e, in order, during the successive steps of further translation (FIGS. 7, 8), in which the cardboard blank 7b is translated by means of the first series of suckers 111a, 111b, 111c, which are still active, to permit folding upwards of the panels 703 and 704, which are engaged by the fixed folding unit 301 during the said successive steps of further translation (FIGS. 7, 8).

This particular supply configuration is often required for so-called wraparound wrapping machines.

In addition, the said particular transport arrangement, wherein two series of suckers which are controlled separately are provided, can be used with other types of fixed or mobile folding units, in order to carry out various operations on the panels of various types of cardboard blanks.

Variant Embodiment

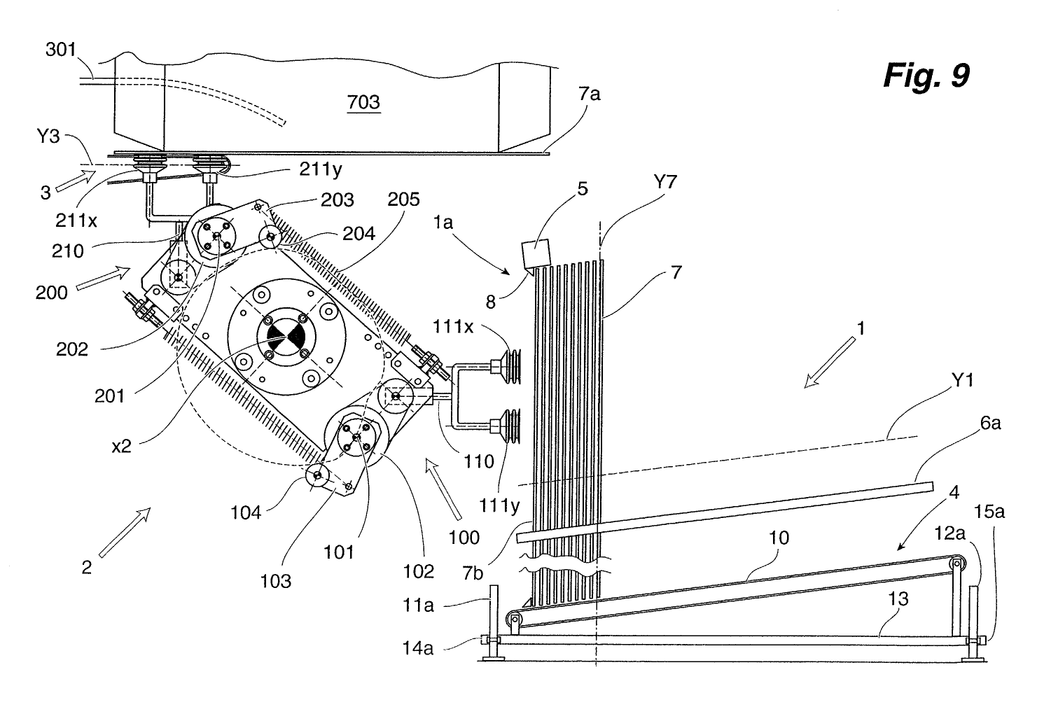

FIG. 9 illustrates a variant embodiment, wherein, substantially, the arms 110 and 211 have a respective end secured to the said orbiting and oscillating shafts 108 and 208, and their respective opposite end which is designed to support two suckers 111x, 111y and 211x, 211y, in order to improve the gripping of the cardboard blank.

The descriptions of the method and the system for transferring flat cardboard blanks in individual succession are provided purely by way of non-limiting example, and thus any modifications or variants suggested by practice, and by their utilisation or use, can be made to this method and this system, within the context of the scope of the following claims.

1. Method for transferring cardboard blanks (7) in individual succession, in a plant comprising: a store (1) for collection of cardboard blanks (7), which extends longitudinally along its own longitudinal axis (Y1), and is designed to present in the vicinity of its downstream end (1a) the cardboard blanks (7) to be transferred; a conveyor (3), which extends longitudinally along its own longitudinal axis (Y3), which is disposed aligned relative to the preceding axis (Y1) of the store (1), wherein the upstream portion (3a) of the said conveyor (3) is designed to receive the cardboard blanks; a rotary collector-translator (2), which is designed to rotate relative to an axis (X2) which is disposed perpendicular to the axes of extension (Y1, Y3) of the store (1) and of the conveyor (3), and is disposed between the downstream end (1a) of the said store (1) and the upstream portion (3a) of the said conveyor (3), and comprises one or a plurality of orbiting gripper units (100, 200), which are designed to collect the cardboard blanks (7) in succession from the downstream end (1a) of the store (1), and then to translate them onto the upstream portion (3a) of the conveyor (3), characterised in that the transfer of each individual cardboard blank (7b) comprises the following operations:
a) gripping of the cardboard blank (7b) at the downstream end (1a) of the store (1);
b) extraction of the cardboard blank (7b) from the downstream end (la) of the store (1);
c) translation of the cardboard blank (7b) towards the axis of rotation (X2) of the rotary collector-translator (2), whilst keeping the said cardboard blank (7b) substantially parallel relative to the successive cardboard blank (7c), which is still disposed in the vicinity of the downstream end (1a) of the store (1);
d) spacing the cardboard blank (7b) which is being translated, from the successive cardboard blank (7c), which is still disposed in the vicinity of the downstream end (1a) of the store (1), whilst keeping the said cardboard blank (7b) which is being translated substantially parallel to the successive cardboard blank (7c), which is still disposed in the vicinity of the downstream end (1a) of the store (1);
e) inclining the cardboard blank (7b) which is being translated, whilst taking its front portion (71b) towards and above the upstream portion (3a) of the conveyor (3); and
f) placing at least this front portion (71b) of the cardboard blank (7b) which is being translated, parallel above, and in contact with, the upstream portion (3a) of the conveyor (3).

2. Method according to claim 1, characterised in that during step a), the cardboard blank (7b) to be transferred is grasped in an area (70) which has a pre-determined longitudinal distance (Y71) relative to the front end of the cardboard blank (7b), in order to determine the front portion (71b) for the said cardboard blank (7b), and in that during the step f), at least the said front portion (71 b) of the cardboard blank (7b) is grasped by means of the said upstream portion (3a) of the said conveyor (3).

3. Method according to claim 2, characterised in that by using cardboard blanks which have a different longitudinal length (Y7+Y71), the different cardboard blanks are grasped at a point (70) which always has substantially the same longitudinal distance (Y71) relative to the front end of the cardboard blank used.

4. System for transferring cardboard blanks (7) in individual succession, in a plant comprising: a store (1) for collection of cardboard blanks (7), which extends longitudinally along its own longitudinal axis (Y1), and is designed to present in the vicinity of its downstream end (1a) the cardboard blanks (7) to be transferred; a conveyor (3), which extends longitudinally along its own longitudinal axis (Y3), which is disposed aligned relative to the preceding axis (Y1) of the store (1), wherein the upstream portion (3a) of the said conveyor (3) is designed to receive the cardboard blanks; a rotary collector-translator (2), which is designed to rotate relative to an axis (X2) which is disposed perpendicular to the axes of extension (Y1, Y3) of the store (1) and of the conveyor (3), and is disposed between the downstream end (1a) of the said store (1) and the upstream portion (3a) of the said conveyor (3), and comprises one or a plurality of orbiting gripper units (100, 200), which are designed to collect the cardboard blanks (7) in succession from the downstream end (1a) of the store (1), and then to translate them onto the upstream portion (3a) of the conveyor (3), characterised in that each of the said orbiting gripper units (100) comprises one or a plurality of suckers (111), which are controlled such as to move in respective orbital paths, which are disposed in respective planes perpendicular to the axis of rotation (X2) of the said rotary collector-translator (2); in that the upstream portion (3a, 34a, 34b) of the said conveyor (3) extends within the operative context of the orbital path of the said suckers (111); and in that in the execution of their orbital path, the said suckers (111a, 111b, 111c, etc.) pass adjacent to the said upstream portion (3a, 34a, 34b) of the conveyor (3).

5. System according to claim 4, characterised in that the upstream portion (3a) of the said conveyor (3) comprises at least two transporters (30a, 30b), which are disposed transversely spaced from one another, in order to create an aperture (31) which has a pre-determined longitudinal and transverse amplitude; in that at least one sucker (111b) out of the said suckers (111) is controlled such as to orbit in a plane which is aligned with the said aperture (31); and in that in the execution of its orbital path, the said at least one sucker (111b) passes between the said two transporters (30a, 30b), using the said aperture (31).

6. System according to claim 4 or claim 5, characterised in that the said transporters (30a, 30b) are of the suction conveyor type (32a, 32b).

7. System according to claim 4 or claim 6, characterised in that the said suckers (111 ) have a gripping plane with orientation which is substantially parallel to the upper receiver branches (34a, 34b) presented by the said upstream portion (3a) of the conveyor (3), when the said suckers (111) pass adjacent to the said upstream portion (3a) of the conveyor (3).

8. System according to claim 4 or claim 7, characterised in that the said rotary collector-translator (2) and at least one orbiting gripper unit (100) comprise: two rotary elements (20a, 20b), which are disposed facing, and spaced from one another, and are designed to rotate around the axis of rotation (X2); at least one orbiting and oscillating shaft (107-108), which is supported such as to be rotated by, and between, the said pair of rotary elements (20a, 20b), in the vicinity of their radial periphery, is oriented parallel to the said axis of rotation (X2), and is designed to orbit along a circular path; one or a plurality of arms (110), which can be inclined in a plane which is perpendicular to the said axis of rotation (X2), with one end which is fixed to the said orbiting and oscillating shaft (107, 108), and the opposite ends which are designed to support the said suckers (111).

9. System according to claim 8, characterised in that the said orbiting and oscillating shaft (108) has keyed onto it a first toothed wheel (106), in that a toothed belt (109) is wound around the said first wheel (106), in that the said toothed belt (109) is also wound around a second toothed wheel (102), which is supported such as to rotate adjacent to the said first toothed wheel (106), by means of a pin (101), which is supported such as to project axially by the said rotary element (20a), in that the second toothed wheel (102) supports integrally the first end of a lever (103), in that the opposite end of the said lever (103) supports a cam-follower roller (104) in an idle rotary manner, and in that the said cam-follower roller (104) is designed to follow the profile (22) of a stationary cam (23).

10. System for transferring cardboard blanks (7) in individual succession, in a plant comprising: a store (1) for collection of cardboard blanks (7), which extends longitudinally along its own longitudinal axis (Y1), and is designed to present in the vicinity of its downstream end (1a) the cardboard blanks (7) to be transferred; a conveyor (3), which extends longitudinally along its own longitudinal axis (Y3), which is disposed aligned relative to the preceding axis (Y1) of the store (1), wherein the upstream portion (3a) of the said conveyor (3) is designed to receive the cardboard blanks; a rotary collector-translator (2), which is designed to rotate relative to an axis (X2) which is disposed perpendicular to the axes of extension (Y1, Y3) of the store (1) and of the conveyor (3), and is disposed between the downstream end (1a) of the said store (1) and the upstream portion (3a) of the said conveyor (3), and is designed to support one or a plurality of orbiting gripper units (100, 200), which are circumferentially equally spaced, and are designed to collect the cardboard blanks (7) in succession from the downstream end (1a) of the store (1), and then to translate them onto the upstream portion (3a) of the conveyor (3), characterised in that each orbiting gripper unit (100/200) of the said rotary collector-translator (2) comprises: -an orbiting and oscillating shaft (108/208), which is supported such as to be rotated by, and between, two rotary elements (20a, 20b), in the vicinity of their radial periphery, is oriented parallel to the said axis of rotation (X2) of the rotary collector-translator (2), and is designed to orbit along a circular path; one or a plurality of arms (110, 110a, 110b, 110c, 110d, 110e/210, 210a, 210b, 210c, 210d, 210e), which can be inclined in respective planes which are perpendicular to the said axis of rotation (X2), and have one end which is secured to the said orbiting and oscillating shaft (108/208), and the opposite end which is designed to support respective orbiting suckers (111, 111a, 111b, 111c, 111d, 111e 211, 211a, 211b, 211c, 211d, 211e); a first toothed wheel (106/206), which is keyed onto the said orbiting and oscillating shaft (108/208); a second toothed wheel (102/202), which is supported such as to rotate adjacent to the said first toothed wheel (106/206), by means of a pin (101/201) which projects axially from one of the said rotary elements (20a); a toothed belt (109/209), which is wound around the said first toothed wheel (106/206) and around the said second toothed wheel (102/202); and a lever (103/203), which has a first end secured to the said second toothed wheel (102/202), and the opposite, or second, end designed to support in an idle rotary manner a cam-follower roller (104/204), and in that the cam-follower rollers (104/204) of each orbiting gripper unit (100/200) are designed to follow the profile (22) of a common stationary cam (23).

11. System according to claim 9 or claim 10, characterised in that the said profile (22) of the said stationary cam (23) has a section (23a-23b) which is designed to oscillate the arms (110) of the suckers (111) in a direction (F2) opposite the direction (F1), wherein the said collector-translator (2) is rotated, in order to create a halt, during which contact is made with a cardboard blank (7b), which is then grasped and extracted from the store (1).

12. System according to any one of claims 9 to 11, characterised in that the said profile (22) of the stationary cam (23) has a section (23b-23c) which is designed to oscillate the arms (110) of the suckers (111) in a direction (F2) opposite the direction (F1), wherein the said collector-translator (2) is rotated, in order to translate the cardboard blank (7b) towards the centre of rotation (X2), after it has been extracted, whilst keeping it parallel to the cardboard blank (7c) which is disposed in the vicinity of the downstream end of the store (1).

13. System according to any one of claims 9 to 12, characterised in that the said profile (22) of the stationary cam (23) has a section (23c-23d) which is designed to oscillate the arms (110) of the suckers (111), such that the gripping plane of the said suckers (111) is parallel to the receiver branch (34a, 34b) of the upstream portion (3a) of the receiver conveyor (3), when the said suckers (111) pass in the vicinity of the said upstream portion (3a).

14. System according to any one of the preceding claims, characterised in that, for each orbiting gripper unit (110/200) it comprises a first series of suckers (111a, 111b, 111c/211a, 211b, 211c), which are controlled by means of first pneumatic distribution (124a/224a), and a second series of suckers (111d, 111e/211d, 211e) which are controlled by means of second pneumatic distribution (124b/224b), in that the said first series of suckers (111a, 111b, 111c/211a, 211b, 211c) is designed to grasp a first longitudinal portion (701, 702) of the cardboard blank, whereas the said second series of suckers (111d, 111e/211d, 211e) is designed to grasp a second longitudinal portion (701, 702) of the cardboard blank, and in that, along the path of translation of the cardboard blank (7b), there is disposed at least one folding unit (301), which is designed to execute operations on the said second longitudinal portion (703, 704) of the cardboard blank (7b), during some translation steps (FIGS. 7-8), in which the said second series of suckers (111d, 111e/211d, 211e) is rendered non-operative.

15. System according to any one of the preceding claims, characterised in that the said store (1) can be raised and lowered vertically relative to the axis of rotation (X2) of the rotary collector-translator (2), in order with cardboard blanks which have different longitudinal extensions (Y7), to obtain a gripping area (70) for the suckers (111, 211) which has a substantially equal portion (71b) of cardboard blank disposed to the front of the said point (70).

16. System according to any one of the preceding claims, characterised in that the said rotary collector-translator (2) comprises two orbiting gripper units (100, 200) which are disposed in an opposite manner.

17. System according to any one of the preceding claims, characterised in that the said rotary collector-translator (2) comprises a plurality of orbiting gripper units (100, 200) which are disposed in a circumferentially equally spaced manner. 18)-System according to any one of claims 8 to 17, characterised in that the arms (110/211) have a respective end secured to the said orbiting and oscillating shafts (108/208), and their respective opposite end designed to support two suckers (111x-111y/211x-211y).
